(19) United States
(12) Patent Application Publication
(10) Pub. No.: US 2011/0300407 A1
(43) Pub. Date: Dec. 8, 2011

(54) Aluminum-Plated Steel Sheet Having Superior Corrosion Resistance, Hot Press Formed Product Using the Same, and Method for Production Thereof

(75) Inventors: Yeol-Rae Cho, Gwangyang (KR); Tai-Ho Kim, Gwangyang (KR); Sung-Ho Park, Gwangyang (KR); Eung-Ryul Baek, Kyungsan (KR)

(73) Assignee: POSCO, Pohang, Kyungsangbook-do (KR)

(21) Appl. No.: 13/143,614

(22) PCT Filed: Jan. 8, 2010
(86) PCT No.: PCT/KR2010/000133

§ 371 Date: Jul. 7, 2011

(30) Foreign Application Priority Data
Jan. 9, 2009 (KR) 10-2009-0001877

(51) Int. Cl. B32B 15/01; B21D 31/00; B05D 3/00

(52) U.S. Cl. 428/653; 427/398.1; 72/364

(57) ABSTRACT

Provided are a coated steel sheet, a hot press formed product using the steel sheet, and a producing method thereof. Conditions for hot-dip coating bath are optimized when an aluminum-coated steel sheet is produced using a hot rolled steel sheet or a cold rolled steel sheet, and processes are controlled during production of a hot press formed product from the steel sheet, thereby forming a coating layer having a high ratio of (Fe₃Al+FeAl) compound layer on the surface of the steel sheet. In cases where the (Fe₃Al+FeAl) compound layer has an appropriate occupancy ratio with respect to the whole thickness of the coating layer, good resistance against crack and corrosion can be achieved to improve a local corrosion resistance of the hot press formed product, particularly, a pitting corrosion resistance. Therefore, high-quality hot press formed products can be produced with high productivity and lower costs.

### TECHNICAL FIELD

The present invention relates to an aluminum alloy-coated steel sheet for a hot press forming, a hot press formed product using the steel sheet, and a producing method thereof, and more particularly, the present invention relates to: an aluminum-coated steel sheet having an improved local corrosion resistance such as a pitting corrosion resistance so that a high-strength product can be made of the aluminum-coated steel sheet by hot press forming; a hot press formed product using the steel sheet; and a producing method thereof.

### BACKGROUND ART

Recently, various safety laws for the protection of vehicle passengers as well as fuel efficiency regulations for environmental protections have been reinforced by the social demands. In this regard, an improvement in the strength and the weight reduction of structural members used in vehicles is becoming more important to the automotive industry.

For example, the automotive component directly related to safety of cage zone where passengers stay in a vehicle, include a pillar reinforcement and a cross member as well as crash zone. Those automotive components are constituted by side member and front and front/rear bumpers that require the ultra-high strength steel sheet in order to ensure safety and increase fuel efficiency.

However, in most cases, an increase in strength of a steel sheet may result in reduction of formability caused by an increase of yield strength and a reduction of elongation. Also, due to an excessive spring-back problem after a forming process, there may be a limitation of lowering a so-called shape freezing property in which dimensions of a product are changing after a forming process.

To solve this limitation, various advanced high strength steels (AHSS) have been developed and are now used in practice. For example, advanced high strength steels include dual phase (DP) steel and transformation induced plasticity (TRIP) steel. The DP steel has a ferrite phase as a matrix and a martensite phase as a secondary phase to improve a low yield ratio characteristic. The TRIP steel includes bainite and retained austenite phases into a ferrite phase matrix to adjust a strength-elongation balance. These steels have superior formability compared with typical high strength steels for automobile applications.

However, as described above, when the strength of a material increases, high forming force is required to form automobile parts such that press capacity and load should be increased. This may relate to limitations of an increased tool wear or a tool life reduction, thus causing a limitation that may reduce productivity. A roll forming method, which may produce a product with a lower forming force than a press forming method, has been recently introduced. However, since the roll forming method is only applicable to a product having a relatively simple shape, a limitation, in which the roll forming method is difficult to be applied to the complicated automotive parts or the like requiring large-sized parts, still exists.

Recently, a forming method, called as a hot press forming (hereinafter, HPF) or a hot forming, has been proposed as a method for producing automotive parts having ultra-high strength of 1000 MPa or more by the forming of the foregoing high strength steels. The HPF method performs a so-called die quenching in which a steel sheet having an excellent hardenability, such as 22MnB5, is heated up to an austenite region and then extracted to perform a hot forming and a cooling at the same time using tool equipped with cooling device. By the HPF method, a product having an ultra-high strength equal to or more than 1000 MPa may not only be easily obtained, but also a product having very high dimensional accuracy may be obtained. Hence, the hot press forming receives many attentions as a very effective automotive parts forming method in manufacturing a light-weight automobile and improving rigidity.

Basic concepts of the HPF method and chemical composition of steels used herein were initially proposed in Patent No. GB1490535 and were subsequently commercialized. Thereafter, the USINOR defined a critical reason for each chemical composition range similar to the GB1490535 patent in 1998, and the U.S. Pat. No. 6,296,805, which relates to a coated steel sheet produced by coating a steel sheet with aluminum or an aluminum alloy in order to suppress an oxide film formed on a surface of a steel sheet during a heating step of an HPF process and improve corrosion resistance of a product after a hot press forming, is proposed and then commercialized.

An aluminum-coated steel sheet before used as steel for an HPF application will be described. Patent applications for aluminum-coated steel sheets have been filed and aluminum-coated steel sheets have been commercialized in Germany, U.S.A, and other countries since 1893. In particular, aluminum-silicon (Al—Si) coated steel sheets, which contain 9˜10 wt % of Si and have superior heat resistance characteristics, have been commercialized in the U.S.A. Thereafter, pure aluminum-coated steel sheets having superior corrosion resistance have also been commercialized. An addition of Si to an aluminum alloy is to increase the fluidity of hot-dip aluminum bath, and simultaneously, to improve the formability of coated steel sheets by suppressing the growth of an iron-aluminum (Fe—Al) alloy layer (particularly, FeAl₃) formed between a Fe-base and a coating layer. Also, an aluminum-coated steel sheet shows an improvement of corrosion resistance, and it is known that this improvement is caused by a dense aluminum oxide layer formed on the surface of the steel sheet according to the elapsed time.

Before the year 2000, a typical cold rolled steel sheet of 22MnB5 was mainly used for HPF steel, and a surface oxide layer formed during an HPF process was removed by performing an additional short blast treatment. However, while an aluminum-coated steel sheet commercialized in the early 2000s was applied to the producing of HPF parts, the short blast treatment could be omitted, and a coating weight is generally standardized as 80 g/m². An aluminum steel sheet for an HPF application, which was proposed by the USINOR company, is characterized in that a hot-dip coating is performed with an aluminum alloy containing 9˜10 wt % of Si and 2.0˜3.5 wt % of Fe on a surface of a steel sheet which has a chemical composition system of 0.22% carbon (C)—1.2% manganese (Mn)—50 ppm or less of boron (B) as a basis and titanium (Ti) and chromium (Cr) are added thereto. While the aluminum coating layer is changed into multi-layers of intermetallic compounds during an HPF heating process, the formation of surface iron oxide may be suppressed.

Generally, a coating layer existed in an aluminum-coated steel sheet includes two layers. One is an FeAl₃ layer (about 2˜5 μm in the related art) formed to face a steel matrix, and the other is an α-Al layer (about 25˜30 μm in the related art) close to the surface.

If an HPF process including heating is performed in a state where the Fe—Al layer exists, the coating layer is changed to a number of intermetallic compounds layers and thickness of the coating layer is increased. For example, a number of intermetallic compounds layers of Fe₃Al, FeAl, Fe₂Al₅, and FeAl₃, etc., are formed from a Fe-base toward a surface.

When looking into these layers, layers near the surface contain more aluminum, and layers near the Fe-base contain more Fe. As described above, aluminum contained in the intermetallic compounds may contribute to the formation of a passive film, thus contributing to improve a corrosion resistance of a product produced by an HPF.

However, the intermetallic compounds have different properties from each other, and some of them particularly exhibit high brittleness. Thus, cracks may occur from a surface layer toward a Fe-base when tensile stress is generated during cooling due to a thermal shrinkage difference and non-uniform temperatures existed between intermetallic compounds. FIG. 1 is a photograph showing such cracks. If the cracks of a coating layer are formed, although a thick alloy coating layer equal to or more than 30 μm is formed by an HPF process, corrosion inevitably occurs along the cracks so that local corrosion, particularly pitting corrosion, will be accelerated.

Therefore, in the case where an aluminum-coated steel sheet is adopted to use in the automobile or the like, there are continuous needs for methods which can suppress generation of cracks and local corrosion in a coating layer after an HPF.

### DISCLOSURE

### Technical Problem

An aspect of the present invention provides an aluminum-coated steel sheet, a hot press formed product, and a producing method thereof, which can effectively reduce the generation and propagation of cracks in a coating layer that may be generated after an HPF, in order to suppress corrosion problem, particularly a local corrosion, which may occur in a typical aluminum-coated steel sheet, in the case of an aluminum-coated steel sheet produced from a hot rolled steel sheet or a cold rolled steel sheet and producing an HPF product using the aluminum-coated steel sheet.

### Technical Solution

According to an aspect of the present invention, there is provided an aluminum-coated steel sheet including a coating layer of aluminum coated on a surface of a base steel sheet in a coating weight of 20˜80 g/cm². The coating layer may include 12 wt % or less of silicon (Si), 0.7 wt % or less of chromium (Cr), and 0.7 wt % or less of molybdenum (Mo). A hot rolled steel sheet or a cold rolled steel sheet may be used as the base steel sheet.

According to another aspect of the present invention, there is provided a method for producing an aluminum-coated steel sheet, the method including: heating a steel sheet to 750˜850° C.; dipping the heated steel sheet into an aluminum coating bath containing 12 wt % or less of silicon (Si) and coating the heated steel sheet at a coating weight of 20˜80 g/m²; and cooling the coated steel sheet to room temperature at a cooling rate of 5˜15° C./sec. In this case, the steel sheet may be a hot rolled steel sheet or a cold rolled steel sheet. The hot-dip aluminum bath may include 0.7 wt % or less of chromium (Cr) and/or 0.7 wt % or less of molybdenum (Mo).

According to another aspect of the invention, there is provided a hot press formed product including: a coating layer having a (Fe₃Al+FeAl) compound layer on a surface of a base steel sheet. In this case, the steel sheet may be an aluminum-coated steel sheet produced using a hot rolled steel sheet or a cold rolled steel sheet. The coating layer may include 12 wt % or less of silicon (Si). The (Fe₃Al+FeAl) compound layer may have an occupancy ratio of 30% or more with respect to the total thickness of the coating layer.

According to another aspect of the present invention, there is provided a method for producing a hot press formed product, the method including: preparing an aluminum-coated steel sheet including an aluminum coating layer as a blank for hot press forming (HPF); heating the blank at a temperature of 820˜970° C.; maintaining the temperature of the heated blank and extracting the heated blank; transferring the blank to a prepared tool and hot-forming the blank by using a press; and cooling the pressed blank while maintaining the blank in the tool. In this case, the aluminum coating layer may include 12 wt % or less of silicon (Si). The maintaining of the temperature of the heated blank may continue for 3 minutes or more. The tool may be cooled to 200° C. or less at a cooling rate of 20° C./sec or more.

### Advantageous Effects

Exemplary embodiments of the present invention may provide an aluminum-coated steel sheet and a hot press formed product, in which production is easy and producing conditions are simple as well as an ability to prevent crack propagation is excellent such that a local corrosion resistance of the hot press formed product, particularly a corrosion resistance against pitting corrosion, is remarkably improved.

### DESCRIPTION OF DRAWINGS

FIG. 1 is a micrograph showing coating layer cracks observed in a typical aluminum-coated steel sheet for an HPF.

FIG. 2 shows a graph (FIG. 2A) showing 40% of thickness occupancy ratio curves of a (Fe₃Al+FeAl) layer by coating weights depending on heating temperatures and heating time in an aluminum-coated steel sheet, and a graph (FIG. 2B) showing changes in thickness occupancy ratios of a (Fe₃+FeAl) layer under the same coating weight condition.

FIG. 3 is a graph showing a relationship between a coating weight and a (Fe₃Al+FeAl) layer thickness with respect to a heating temperature in an aluminum-coated steel sheet for an HPF application which has superior corrosion resistance according to the present invention.

FIG. 4 presents photographs showing corrosion resistance evaluation results of the related art and the present invention.

### BEST MODEL

The inventors of the present invention investigated the relationship between an alloying process of a coating layer and a crack generation in a coating layer presented when a hot press forming (HPF) process or a heat treatment corresponding to the HPF process was performed using an aluminum-coated steel sheet containing Si.

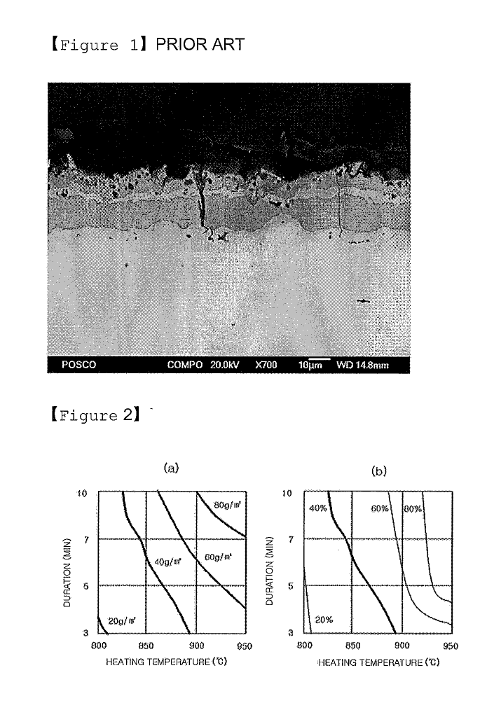

A coating layer which has undergone a heating process is transformed into a number of alloyed coating layers. At this time, vertical cracks occurring in the coating layer, as in FIG. 1, start from a surface of the coating layer, moves toward a base steel sheet, and do not propagate any further from a (Fe₃Al+FeAl) layer. However, a coating weight of a commercial aluminum-coated steel sheet is generally 80 g/m². Based on this value, the (Fe₃Al+FeAl) layer has a thickness of 5˜15 μm even after an HPF process, and a ratio occupied in the heat-treated coating layer is only 30% or less such that a function of preventing crack propagation is relatively insufficient.

Meanwhile, cracks generated in the coating layer frequently occur in intermetallic compounds layers having a relatively large amount of Al, such as FeAl₂, Fe₂Al₅, and FeAl₃. This is because that these compounds layers have high brittleness although in a hot state and additionally, tensile stresses, which are originated by a thermal shrinkage difference and non-uniform temperatures between the intermetallic compounds during a cooling process, may cause crack generation in the intermetallic compounds layers.

Therefore, the inventors of the present invention conducted continuous research related to methods which can improve a corrosion resistance of an aluminum-coated steel sheet undergone an HPF process, and as a result, completed the present invention.

The present invention relates to an aluminum-coated steel sheet capable of improving a corrosion resistance of a final HPF product and a producing method thereof. Also, the present invention relates a hot press formed product and a producing method thereof, in which a structure of an alloyed coating layer is formed and optimized to prevent corrosion by appropriately controlling heating conditions in an HPF process.

(1) Aluminum-Coated Steel Sheet and Producing Method Thereof

Hereinafter, an aluminum-coated steel sheet capable of improving corrosion resistance and a producing method thereof will be described in more detail.

In an optimized aluminum-coated steel sheet according to the present invention, a coating layer exists on the surface of a base steel sheet in a coating weight of 20˜80 g/m², and as a result, a coating weight is controlled such that a (Fe₃Al+FeAl) compounds layer may be formed to have 30% or more of an occupancy ratio based on a coating layer thickness during an HPF process. In this case, the coating layer may include equal to or less than 12 wt % of Si, and may further include more than one or two selected from equal to or less than 0.7 wt % of Cr or equal to or less than 0.7 wt % of Mo. In the present invention, a base steel sheet may include a hot-rolled steel sheet, a cold-rolled steel sheet, and an uncoated cold-rolled steel sheet.

Furthermore, a method for producing an aluminum-coated steel sheet includes: heating a hot-rolled steel sheet or a cold-rolled steel sheet at 750˜850° C.; dipping the heated steel sheet into an aluminum bath containing equal to or less than 12 wt % (excluding 0%) of Si, Fe and other unavoidable impurities and controlling a coating weight to 20˜80 g/m²; and cooling the coated steel sheet to room temperature at a cooling rate of 5˜15° C./sec.

The reason for limiting each technical factor is as follows.

Aluminum Coating Weight: 20˜80 g/m²

An aluminum coating weight, together with a heating temperature and heating time, is one of most important factors promoting the generation of a (Fe₃Al+FeAl) intermetallic compounds layer during an HPF process. In an alloy coated steel sheet, a growth of the alloying layer is fundamentally affected by temperature and time. This is because that as the coating weight is smaller, alloying reaction between aluminum coating layer and base steel matrix increases to promote a growth of the (Fe₃Al+FeAl) intermetallic compounds layer.

Therefore, the aluminum coating weight is limited to the range of 20˜80 g/m². Since a coating layer having 20 g/cm² or less has a low coating weight, an occupancy ratio of the (Fe₃Al+FeAl) intermetallic compounds layer may be increased within a short period of time during a subsequent HPF process, but an entire thickness of the coating layer may be too thin. On the other hand, in the range of exceeding 80 g/cm², since the growth of the (Fe₃Al+FeAl) intermetallic compounds layer is prevented during the HPF process, the occupancy ratio may be lowered.

Silicon (Si) Content in a Coating Bath (Coating Layer): Equal to or Less than 12 wt %

As the Si content in a coating bath increases, fluidity increases such that there is an advantage that coating is possible at a lower hot-dip bath temperature. Therefore, typically, a large amount of Si has been often added to the coating bath.

However, when a coating layer undergoes a heating process like an HPF process, the coating layer of a coated steel sheet is changed into another type of coating layer including various intermetallic compounds layers. That is, iron (Fe) atoms existing in a base steel sheet are diffused into the coating layer, and a FeAl₃ alloy phase on the interface of the base steel sheet formed during a coating process is transformed into Fe₃Al and/or FeAl intermetallic compounds. Finally, since various layers, such as Fe₃Al, FeAl, Fe₂Al₅, and Fe—Al₂O₃, are formed toward a surface from the base steel sheet, it is not necessary to add a large amount of Si when the coating layer undergoes an HPF process. Therefore, the Si content of the coating bath or the coating layer may be limited to equal to or less than 12 wt %, preferably equal to or less than 8 wt % or more preferably equal to or less than 5 wt %.

Chromium (Cr) Content in the Coating Bath (Coating Layer): Equal to or Less than 0.7 wt %

Cr in the coating bath is dissolved in the intermetallic compounds during an HPF process and functions as an effective element in forming an oxide film, therefore, Cr may be added in the present invention. When the Cr content is exceeding 0.7 wt %, the effect relative to the added amount may be reduced and manufacturing cost may be increased. Thus, the Cr content is limited to equal to or less than 0.7 wt %.

Molybdenum (Mo) Content in a Coating Bath (Coating Layer): Equal to or Less than 0.7 wt %

Mo is an element that helps to form an oxide film by dissolving in the intermetallic compounds during an HPF process while existing in the coating layer. It is known that the effect of Mo is more effective than that of Cr. Therefore, an appropriate amount of Mo may be added in the present invention. When the Mo content is exceeding 0.7 wt %, the effect relative to the added amount may be reduced and producing cost may be increased. Thus, the Mo content is limited to equal to or less than 0.7 wt %.

Cooling Rate: Cooling to Room Temperature at a Cooling Rate of 5˜15° C./Sec

If cooling rate of the coated steel sheet is reduced, the line speed of coating line should be reduced and thus, productivity is also reduced, and pick-up defects of molten aluminum may occur on the surface of the steel sheet so that the cooling should be performed at the rate of equal to or more than 5° C./sec. On the other hand, if the cooling rate is too high exceeding 15° C./sec, low temperature microstructures such as bainite or martensite may be formed. Consequently, strength of the coated steel sheet before blanking increases to reduce the service life of a blanking tool. Thus, an upper limit of the cooling rate is controlled to 15° C./sec.

Also, an aluminum-coated steel sheet or an aluminum alloy-coated steel sheet may be produced by a dry coating method such as a chemical vapor deposition. In this case, a base steel sheet during the producing of a coated steel sheet may be produced using the hot-rolled steel sheet or the cold-rolled steel sheet.

(2) HPF Product and Producing Method Thereof

As described above, the present invention provides an HPF product produced from an aluminum-coated steel sheet coated using the hot-dip coating bath, and a producing method thereof. The producing method includes: preparing a blank for an HPF application; heating the blank at a temperature of 820˜970° C.; extracting the heated blank after maintaining the heated blank for 3 minutes or more; performing a hot forming on the extracted blank by a press after extracting; and performing a die quenching to the temperature of equal to or less than 200° C. at a cooling rate of equal to or more than 20° C./sec by maintaining the hot formed blank in a tool. Also, a product produced like this may have more than 30% of a thickness occupancy ratio of a (Fe₃Al+FeAl) intermetallic compounds layer such that improved corrosion resistance may be obtained.

Hereinafter, the product and the manufacturing method thereof will be described in more detail.

An aluminum-coated steel sheet and an aluminum alloy-coated steel sheet produced under hot-dip coating bath condition of the present invention, or an aluminum-coated steel sheet and an aluminum alloy-coated steel sheet manufactured by general dry coating are prepared as blanks by considering a shape of the final product, and then are produced as parts for the automobiles or the like by an HPF process thereafter.

Regarding to a heating temperature and heating time for the formation of a coating layer, lower temperature and shorter time than the conventional for a typical HPF process with aluminum-coated steel sheet are used in the present invention. In the present invention, heating temperature is limited to 820˜970° C., and heating time is limited to 3 minutes or more. This is an experimentally obtained result of conditions for the growing of an optimized (Fe₃Al+FeAl) intermetallic compounds layer with respect to the range of the aluminum coating weight. If the heating temperature is too low and the heating time is too short, the growing of the (Fe₃Al+FeAl) intermetallic compounds layer may not be properly performed. On the other hand, if the temperature is too high or the duration is too long, undesired results are obtained in productivity aspect. This will be described below in detail.

### Coating Layer Thickness Occupancy Ratio of a (Fe₃Al+FeAl) Intermetallic Compounds Layer: 30% or More

It is important that a product undergone an HPF process with the foregoing conditions has 30% or more of a thickness occupancy ratio of the (Fe₃Al+FeAl) intermetallic compounds layer. If 30% or more of the (Fe₃Al+FeAl) intermetallic compounds layer are formed, improvement for superior corrosion resistance may be obtained. If the occupancy ratio increases equal to or more than 40%, local corrosion resistance is remarkably more improved. Thus, the occupancy ratio may be controlled to equal to or more than 40%.

Blank Heating Temperature: 820˜970° C.

The blank heating temperature may be somewhat different according to a strength level required in the final product, however, in a typical HPF process, heating is performed up to more than Ac₃ of an austenite region in many cases. In the present invention, the heating temperature is equal to or more than 820° C. in order to control the degree of alloying reaction of the aluminum coating layer which is effective to the improvement of corrosion resistance. If the heating temperature is 820° C. or less, a thickness occupancy ratio of the (Fe₃Al+FeAl) intermetallic compounds layer becomes 30% or less like in a typical aluminum-coated steel sheet such that it is difficult to obtain sufficient improvement of corrosion resistance. On the other hand, if the heating temperature is too high exceeding 970° C., the thickness occupancy ratio of the (Fe₃Al+FeAl) intermetallic compounds layer is increased. However, it may not be desirable to economy or productivity aspect, and excessive aluminum oxide may be locally formed such that non-uniformity of an irregular surface coating layer may be obtained.

### Blank Heating Duration: 3 Minutes or More

The blank is maintained in a heating temperature range for 3 minutes or more. The maintaining of temperature is a homogenizing heat treatment for providing a homogenous temperature throughout the blank, and this is performed to obtain 30% or more of an overall thickness occupancy ratio of the (Fe₃Al+FeAl) intermetallic compounds layer. Meanwhile, it is unnecessary to set an upper limit of the heating time. The heating time may be selectively set according to situations by those skilled in the art. The heating time may be maintained 3˜10 minutes.

While the temperature and holding time of the present invention are lower and shorter than the conventional aluminum-coated steel sheet, the (Fe₃Al+FeAl) alloy layer hindering propagation of cracks may increase, and a Fe₂Al₅ layer causing the generation of cracks may be relatively reduced. Therefore, the condition for improvement of corrosion resistance expected in the present invention can be easily satisfied. Also, it is expected to reduce the cost of the HPF process and improve the productivity of the product.

Cooling Rate: 20˜300° C./Sec

The cooling rate during the HPF process is related to the maximal generation of martensite phase within the steel sheet in order to ensure the strength of the steel sheet. Therefore, when the cooling rate is low, low strength phases such as ferrite or pearlite phases may be formed. Thus, the cooling is performed at the rate of equal to or more than 20° C./sec. As the cooling rate is increased, a martensite phase can be formed more easily, and uniform ultra-high strength can be obtained in the whole product. For this reason, it is unnecessary to define the upper limit of the cooling rate. However, it is very difficult to realize a cooling rate of higher than 300° C./sec. Also, additional equipment for the cooling process is required, and it is uneconomical. Therefore, the desired upper limit of the cooling rate is 300° C./sec.

The blank formed through the above-described processes is hot-formed by a press and may be produced in a shape having the same dimension as that of the final product. When the cooling is performed at the cooling rate of the present invention, an ultra-high strength product can be produced. The features of the product produced by the method of the present invention will be described in more detail.

### MODE FOR INVENTION

Hereinafter, the present invention will be described in more detail with reference to the following embodiments.

### Embodiment 1

This embodiment relates to an occupancy ratio of a (Fe₃Al+FeAl) compound layer to the entire coating layer according to the heating temperature and the heating time after the HPF treatment. The chemical composition range of the steel sheet used in the experiment included C: 0.15˜0.35 wt %, Si: 0.5 wt % or less, Mn: 1.5˜2.2%, P: 0.025% or less, S: 0.01% or less, Al: 0.01˜0.05%, N: 50˜200 ppm, Ti: 0.005˜0.05%, W: 0.005˜0.1%; B: 1˜50 ppm, and a remainder being Fe and necessary impurities, in which Ti/N: 3.4 or less, Ceq: 0.48˜0.58, and Ar3 temperature is 670˜725° C.; however, it is not limited thereto. Also, 9 wt % of Si was contained in the coating bath, and the coating weight was 20, 40, and 80 g/m² per side. In each case, the heating temperature was maintained at 800˜970° C., and the occupancy ratio of the (Fe₃Al+FeAl) intermetallic compounds layer was targeted to equal to or more than 40%. The relationship when the heating temperature was maintained for 3˜10 minutes is shown in FIG. 2.

FIG. 2A is a graph showing that a thickness occupancy ratio of a (Fe₃Al+FeAl) intermetallic compounds layer in the coating weight of 40˜80 g/m² is 40%. When the coating weight is 80 g/m², it is necessary to perform the heating for 7 minutes or more at 970° C. and for 10 minutes or more at 900° C. in order to control the occupancy ratio to equal to or more than 40%. However, as the coating weight is decreased, the heating temperature to obtain the occupancy ratio of equal to or more than 40% is further reduced. Also, the heating duration time is shortened.

FIG. 2B is a graph showing changes in thickness occupancy ratios of a (Fe₃Al+FeAl) layer according to the change in the heating temperature and the heating time when the coating weight was 40 g/m². As can be seen from FIG. 2B, as the heating temperature increases and the heating duration time increases, the occupancy ratio of the intermetallic compounds layer increases.

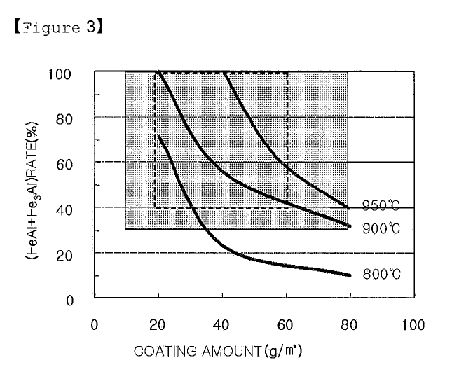

FIG. 3 shows a relationship between a coating weight and a thickness occupancy ratio of a (Fe₃Al+FeAl) layer, based on the heating temperature. In this case, the heating time was limited to 7 minutes. As can be seen from FIG. 3, as the coating weight was reduced, the (Fe₃Al+FeAl) layer of equal to or more than 40% could be easily obtained even at a low temperature.

As can be seen from this embodiment, when the coating weight is more than 80 g/m², it is very difficult for the (Fe₃Al+FeAl) layer to obtain the occupancy ratio of equal to or more than 40%. Thus, it is inefficient in terms of energy reduction. Therefore, the upper limit of the aluminum coating weight may be set to 80 g/m² particularly, 60 g/m² Since the aluminum coating weight must be at least 20 g/m² in order to obtain the uniform aluminum coating layer, the lower limit of the coating weight may be limited to 20 g/m².

### Embodiment 2

In this embodiment, steel sheets having different occupancy ratios of (Fe₃Al+FeAl) layers with respect to the coating layer were produced while changing the coating weight of the aluminum-coated steel sheet and the heating condition of the HPF process. The tensile strength and corrosion resistance of the steel sheets were evaluated.

As described above, there is no specific limitation to the chemical composition system of the hot rolled steel sheet or the cold rolled steel sheet as a source sheet used in producing the aluminum-coated steel sheet or the aluminum alloy-coated steel sheet. However, it is sufficient if the steel sheet has a chemical composition and hardenability sufficient to obtain a targeted strength and phase after the hot press forming. The chemical composition range of the steel sheet used in this embodiment is expressed as wt %.

The composition range of the usable steel sheet is as follows: C: 0.15˜0.35 wt %, Si: 0.5 wt % or less, Mn: 1.5˜2.2%, P: 0.025% or less, S: 0.01% or less, Al: 0.01˜0.05%, N: 50˜200 ppm, Ti: 0.005˜0.05%, W: 0.005˜0.1%; B: 1˜50 ppm, and a remainder being Fe and necessary impurities, in which Ti/N: 3.4 or less, Ceq: 0.48˜0.58, and Ar3 temperature is 670˜725° C.; however, it is limited thereto. An pickling process was performed on the hot rolled steel sheet, and a cold rolling was performed. In this manner, the resulting steel sheet was used as the aluminum-coated steel sheet. The experimental results for the steel sheets used in the experiment and the physical properties after the heat treatment are shown in Table 1 below.

TABLE 1

| Type | | | Coating | | | | | | | Tensile strength after | | | |
|---|---|---|---|---|---|---|---|---|---|---|---|---|---|
| of | Thickness | Coating | weight | Chemical component | | | | | | heat treatment | | | |
| steel | (mm) | method | (g/m2) | C | Si | Mn | B | Ti | N | YS | TS | U-El | T-El |
| A | 1.5 | Melt (Al—Si) | 80 | 0.236 | 0.23 | 1.70 | 0.0017 | 0.019 | 0.0125 | 1130 | 1590 | 5.0 | 7.9 |
| B | 1.5 | Melt (Al—Si) | 40 | 0.236 | 0.23 | 1.70 | 0.0017 | 0.019 | 0.0125 | 1149 | 1572 | 5.0 | 6.8 |
| C | 1.5 | Melt (Al—Si) | 80 | 0.236 | 0.23 | 1.70 | 0.0017 | 0.019 | 0.0125 | 1145 | 1557 | 4.1 | 6.2 |
| D | 1.5 | Melt (Al—Si) | 40 | 0.236 | 0.23 | 1.70 | 0.0017 | 0.019 | 0.0125 | 1159 | 1569 | 4.7 | 7.3 |
| E | 1.3 | Melt (Al—Si) | 20 | 0.244 | 0.25 | 1.67 | 0.0013 | 0.027 | 0.0110 | 1185 | 1604 | 4.2 | 5.9 |
| F | 1.3 | Dry (Al) | 20 | 0.244 | 0.25 | 1.67 | 0.0013 | 0.027 | 0.0110 | 1181 | 1633 | 4.8 | 5.9 |
| G | 1.3 | Dry (Al) | 20 | 0.244 | 0.25 | 1.67 | 0.0013 | 0.027 | 0.0110 | 1185 | 1624 | 4.6 | 6.0 |

As can be seen from Table 1 above, the aluminum-coated steel sheets A to E were controlled such that the coating weight was 20˜80 g/m² per side of the steel sheet (40˜160 g/m² with respect to both side), and a Si composition of the coating bath were equally 9 wt %. Also, in the case of the aluminum-coated steel sheet (F and G) produced by chemical vapor deposition, pure aluminum containing no Si was deposited, and the coating weight was 20 g/m² per side (40 g/m² with respect to both side). Also, the measurement was carried out under the conditions that the heating temperature was 870˜970° C. and the heating time was changed within a range of 5˜10 minutes.

After the heat treatment, a JIS 5 tensile specimen was processed in a parallel to the rolling direction, and a tensile property was measured. As can be seen from Table 1 above, the tensile strength after the hot press forming was 1,550˜1,660 Mpa, which satisfied the requirement of the 1,500 MPa tensile strength.

### Embodiment 3

Table 2 below shows the layer thickness of intermetallic compounds within the coating layer and the corrosion resistance, which were measured using a scanning electron microscope with respect to the alloy layer of the section of the steel sheet obtained under each set of conditions of embodiment 2. For reference, the corrosion resistance was evaluated by a salt spray tester (5% NaCl solution, 35° C.), and the salt spray time was 24˜96 hours.

TABLE 2

| | | | | | | | | | Occupancy | |
|---|---|---|---|---|---|---|---|---|---|---|
| | | | | | | | | | ratio of | |
| | | | | | | | | | (Fe3Al + | |
| | | | | | | | | | FeAl) | |
| | | | | Heating | | Thickness of coating layer | | | layer | |
| Type | | | Coating | condition | | after heat treatment (μm) | | | within | |
| of | Thickness | Coating | weight | Temp. | Time | Fe3Al + | Fe2Al5 + | Total | coating | Corrosion |
| steel | (mm) | method | (g/m2) | (° C.) | (Min) | FeAl | FeAl2 | thickness | layer | resistance |
| A | 1.5 | Melt | 80 | 870 | 5 | 3.8 | 35.2 | 39.0 | 9.7 | X |
| | | (Al—Si) | | | | | | | | |
| B | 1.5 | Melt | 40 | 870 | 5 | 4.8 | 13.9 | 18.8 | 25.8 | X |
| | | (Al—Si) | | | | | | | | |
| C | 1.5 | Melt | 80 | 950 | 10 | 25.5 | 28.5 | 54.0 | 47.2 | ◯ |
| | | (Al—Si) | | | | | | | | |
| D | 1.5 | Melt | 40 | 950 | 5 | 27.7 | 1.4 | 27.7 | 94.9 | ◯ |
| | | (Al—Si) | | | | | | | | |
| E | 1.3 | Melt | 20 | 950 | 10 | 20.5 | 0.0 | 20.5 | 100.0 | ◯ |
| | | (Al—Si) | | | | | | | | |
| F | 1.3 | Dry | 20 | 900 | 5 | 14.4 | 3.3 | 17.7 | 81.4 | ◯ |
| | | (Al) | | | | | | | | |
| G | 1.3 | Dry | 20 | 950 | 5 | 20.9 | 0.0 | 20.9 | 100.0 | ◯ |
| | | (Al) | | | | | | | | |

As can be seen from Table 2 above, in the case of the aluminum-coated steel sheets A to E, the thickness occupancy ratios of the thickness of the (Fe₃Al+FeAl) layer with respect to the total thickness were 9.7%, 25.8%, 47.2%, 94.9%, and 100%, respectively. In the case of the dry coating, the occupancy ratios were 81.4% and 100%. As described above, the thickness of the coating layer after the HPF heat treatment is determined by the relationship between the heating temperature and time (see FIGS. 2A and 2B). When the necessary temperature and time conditions were not satisfied, the temperature and holding time are increasing and the alloying reaction slowed. Thus, the occupancy ratio of the (Fe₃Al+FeAl) layer with respect to the total thickness was reduced.

Also, the experimental results for corrosion resistance according to the occupancy ratio of the (Fe₃Al+FeAl) layer are shown in FIG. 4. FIG. 4 is a photograph showing the experimental results for corrosion resistance in the steel sheets B, C, D and E. In this case, the degree of corrosion was remarkably reduced when the thickness occupancy ratio of the (Fe₃Al+FeAl) intermetallic compounds layer was high. That is, compared with the specimen B, the degree of corrosion was remarkably improved under the conditions C, D and E. The result similar to the cases D and E was obtained in the case of the dry aluminum coating in which the thickness occupancy ratio of the (Fe₃Al+FeAl) intermetallic compounds was 80% or more.

In other words, compared with the related art, the aluminum-coated steel sheet produced under the coating bath condition of the present invention and the product using the same remarkably improves resistance against local corrosion, specifically, resistance against pitting corrosion.

While the present invention has been shown and described in connection with the exemplary embodiments, it will be apparent to those skilled in the art that modifications and variations can be made without departing from the spirit and scope of the invention as defined by the appended claims.

1. An aluminum-coated steel sheet having a pitting corrosion resistance for a hot press forming process, the aluminum-coated steel sheet comprising:
a base steel sheet; and
a coating layer of aluminum on the base steel sheet in a coating weight of 20˜80 g/cm²,
wherein when a product is produced from the aluminum-coated steel sheet by hot press forming, a (Fe₃Al+FeAl) compound layer is formed on a surface of the product at an occupancy ratio of 30% or more.

2. The aluminum-coated steel sheet of claim 1, wherein the coating layer comprises 12 wt % or less of silicon (Si).

3. The aluminum-coated steel sheet of claim 1, wherein the coating layer comprises at least one of 0.7 wt % or less of chromium (Cr) and 0.7 wt % or less of molybdenum (Mo).

4. The aluminum-coated steel sheet of claim 1, wherein a hot rolled steel sheet or a cold rolled steel sheet is used as the base steel sheet.

5. A method of producing an aluminum-coated steel sheet, the method comprising:
heating a steel sheet to 750˜850° C.;
dipping the heated steel sheet into a hot-dip aluminum coating bath containing 12 wt % or less of Si to coat the heated steel sheet at a coating weight of 20˜80 g/m²; and
cooling the coated steel sheet to room temperature at a cooling rate of 5˜15° C./sec.

6. The method of claim 5, wherein the hot-dip aluminum coating bath comprises at least one of 0.7 wt % or less of chromium (Cr) and 0.7 wt % or less of molybdenum (Mo).

7. The method of claim 5, wherein the steel sheet is a hot rolled steel sheet or a cold rolled steel sheet.

8. A hot press formed product comprising a coating layer comprising a (Fe₃Al+FeAl) compound layer on a surface of the hot press formed product,
wherein the (Fe₃Al+FeAl) compound layer has an occupancy ratio of 30% or more with respect to a thickness of the coating layer.

9. The hot pressed formed product of claim 8, wherein the steel sheet is an aluminum-coated steel sheet produced using a hot rolled steel sheet or a cold rolled steel sheet.

10. The hot press formed product of claim 8, wherein the coating layer comprises at least one of 0.7 wt % or less of chromium (Cr) and 0.7 wt % or less of molybdenum (Mo).

11. The hot press formed product of claim 8, wherein the hot press formed product has a martensite structure or a martensite-bainite structure.

12. A method of producing a hot press formed product, the method comprising:
preparing an aluminum-coated steel sheet comprising an aluminum coating layer as a blank for hot press forming (HPF);
heating the blank at a temperature of 820˜970° C.;
maintaining the temperature of the heated blank and extracting the heated blank;
transferring the blank to a prepared tool and hot-forming the blank by using a press; and
cooling the tool while maintaining the pressed product in the tool.

13. The method of claim 12, wherein the aluminum coating layer comprises 12 wt % or less of silicon (Si).

14. The method of claim 12, wherein the maintaining of the temperature of the heated blank continues for more than 3 minutes.

15. The method of claim 12, wherein in the cooling of the tool, the hot pressed product is cooled at a cooling rate of 20° C./sec or higher.

16. The method of claim 12, wherein in the cooling of the tool, the hot pressed product is cooled to 200° C. or lower.

17. The aluminum-coated steel sheet of claim 2, wherein the coating layer comprises at least one of 0.7 wt % or less of chromium (Cr) and 0.7 wt % or less of molybdenum (Mo).

18. The method of claim 13, wherein in the cooling of the tool, the hot pressed product is cooled to 200° C. or lower.

19. The method of claim 14, wherein in the cooling of the tool, the hot pressed product is cooled to 200° C. or lower.

20. The method of claim 15, wherein in the cooling of the tool, the hot pressed product is cooled to 200° C. or lower.
